(19) United States
(12) Patent Application Publication
(10) Pub. No.: US 2012/0177232 A1
(43) Pub. Date: Jul. 12, 2012

(54) Means for Causing Luminaires to Act as an Audio Transmission and Support Means

(76) Inventor: Robert Katz, Montreal (CA)

(21) Appl. No.: 13/395,974

(22) PCT Filed: Sep. 15, 2010
(86) PCT No.: PCT/IB2010/002416

§ 371 Date: Mar. 14, 2012

Related U.S. Application Data
(60) Provisional application No. 61/276,684, filed on Sep. 15, 2009.

(51) Int. Cl. H04R 1/20; H04R 1/02

(52) U.S. Cl. 381/152; 381/386

(57) ABSTRACT

A luminaire used to support audio equipment and more specifically act as a transmission means to transfer mechanical acoustic energy to a soundboard using inertial type audio transducers. Any part of the luminaire may alternatively be employed to act as a soundboard.

### FIELD OF THE INVENTION

The present invention generally relates to causing luminaires to support inertial type audio actuators and more specifically to act as an audio transmission or audio emitter means.

### BACKGROUND OF THE INVENTION

The amalgamation of common building subsystems has helped in their overall cost reduction. In addition, amalgamating such systems has brought sought after efficiencies in material cost reduction, sharing common parts, and reducing installation time. The inventive means described herein render these as well as other benefits.

Common to almost all buildings and building systems is lighting equipment and lighting systems. Common to some buildings, whether commercial, residential or other, are audio systems. Audio systems are commonly used for background music, paging messages, sound masking and other purposes. To date, these two systems, lighting production and audio reproduction, are commonly used independently in numerous applications including but not limited to building subsystems. A luminaire, or a luminaire system has typically been installed and used as a separate technology when integrated into a building to illuminate the interior or exterior spaces. Equally, luminaries are commonly used as a stand alone system strictly for illumination, visual signaling and other purposes.

Audio systems have equally been used to bring a level of utility separate from that of a luminaire system. Improvement of audio technology as used in but not limited to building technology has been sought by those utilizing audio in the built environment. Equally, improvement of lighting technologies as used in but not limited to building technology has been sought by those utilizing and providing lighting devices.

When considering the installation of both audio and lighting into buildings, speed of installation, ease and cost of installation of the combined systems would then ideally equate to a net savings, and improvement as compared with their individual implementation.

Luminaires are often installed to or within or in the general proximity of the ceiling plenum for various types of building construction. By way of example, luminaires of various kinds are commonly installed and integrated either in suspended ceilings or ceilings fabricated of common building materials such as but not limited to gypsum board or composite ceiling tiles. Additionally, electrical power feeds are essentially collocated with the luminaire systems and are used to supply power to the luminaires.

Audio transducers of the common cone type speaker construction have been commonly used in the distribution of acoustic content in various building structures. They have the negative effect of being visually present within the environment and act independently of other systems within the environment to which they are installed or used. It shall be shown that the inventive means described herein function to visually eliminate the audio transducers and cause them to function in an integrated fashion with other systems within the building or environment in which they will be used.

Filling a space in a building using audio emitting devices other than cone type audio speakers such as distributed mode loudspeakers or inertial type audio actuators has an additional positive effect. For the purposes of this patent an inertial type acoustics transducer or inertial type audio actuators can also be construed to be a distributed mode loudspeaker. Inertial type acoustic transducers acting as a distributed mode loudspeaker more effectively fill a given space with sound as its characteristics propagate sound as a function of 1/radius as opposed to 1/radius squared as with conventional cone type speakers. Equally, full spectrum audio content is propagated more fully than conventional cone type speakers within the space as a function of the wave propagation within a substrate energized by an inertial type acoustic transducer or distributed mode loudspeaker.

What is needed is a way to employ inertial type acoustic transducers or actuators to transmit their energy through luminaires, or generally to materials which can be referred to as substrates found to be within the vicinity of the luminaires. If these substrates are energized by an inertial type acoustic actuators they can be made to act as a soundboard to emit sound.

### SUMMARY OF THE INVENTION

It is therefore an object of the present invention to provide a means to cause a luminaire to transmit acoustic vibration from an inertial type acoustic actuator to a soundboard or substrate to which the luminaire is affixed.

It is therefore an object of the present invention to provide a means for a luminaire to support the installation and utilization of inertial type acoustic actuators to the area in which the luminaire is installed.

It is therefore an object of the present invention to provide a means to cause a luminaire to transmit acoustic vibration from an inertial type acoustic actuator to a surface forming part of the luminaire such that the surface or part of the luminaire acts as a soundboard.

It is further an object of the present invention to provide a means for a luminaire to integrate with the necessary audio equipment needed to cause the surrounding substrates to function as acoustic emitters.

It is further an object of this invention to deliver desired audio content into an environment via the luminaires and without showing the audio emitters.

It is further an object of this invention to deliver audio content by way of a signal transmitted over existing electric power lines feeding the luminaire, by way of Ethernet cables, by way of wireless radio frequency transmission or by other delivery means.

The implementation of an audio system used in large spaces found in a building or other open spaces, would best benefit from audio technology able to fill the space evenly. The disclosure of the invention herein focuses on but shall not be limited to the use of inertial type acoustic actuators. It should be noted that other more common audio transduction means can be used such as standard cone type speakers. The benefits of using the inertial type audio actuator to radiate sound from a substrate and evenly fill a space with sound is at least partially due to the fact that they act like planar radiators. The combination or association of the audio system and the luminaire system form one embodiment of the invention disclosed herein.

Building environments including those where luminaires are integrated often incorporate a number of substrates conducive for the use of inertial type acoustic actuators. Using the luminaire as a transduction means for the acoustic energy of the inertial type acoustic actuator and delivering that energy to the substrate generally collocated to the luminaire is detailed herein.

Luminaires can be used in various inventive ways to support the transmission of acoustic energy to sound emitting substrates found in areas where luminaires are used. Many inventive benefits can be realized by this. With the goal of acoustically energizing the substrates, the luminaries can be used either as support structures for said inertial type acoustic actuators, or as an actual transmission means of audio energy to the substrate such that the material or substrate can act as a soundboard to emit audio.

Associating inertial type acoustic actuators with luminaires or to materials found in the built environment and, in turn, to various substrates, causes desired audio content to be delivered to the actuators and then into the building materials or substrate they are affixed to, whereby the materials or substrate reproduce the desired audio content. The actuators induce mechanical energy into the substrate, causing the substrate to vibrate at audio frequencies emitting sound.

If the luminaire's own structure is conducive to be excited by an inertial type acoustic actuator, then the actual structure of the luminaire may emit the desired sound. The structure referred to may be any part or combination of parts of the luminaire. Various ways of accomplishing these objectives to create environments wherein normal substrates are converted to sound emitters are described in detail below.

### BRIEF DESCRIPTION OF THE DRAWINGS

FIG. 1 is a side elevational view of a luminaire assembly according to a non-restrictive illustrative embodiment of the present invention;

FIG. 2 is a top elevational view of the luminaire assembly of FIG. 1;

FIG. 3 is a side elevational view of a luminaire assembly of a second embodiment of the present invention;

FIG. 4 shows a top elevational view of luminaire assembly of FIG. 3;

FIG. 5 shows a side elevational view of a luminaire assembly of a third embodiment of the present invention;

FIG. 6 is a side elevational view of a luminaire assembly showing an electronic housing in a fourth embodiment;

FIG. 7 is a side elevational view of a luminaire assembly showing an embodiment having two segregated electronic housings;

FIG. 8a is a top elevational view of a luminaire assembly with a slide mount embodiment of the present invention;

FIG. 8b is a side elevational view of luminaire assembly of FIG. 8a;

FIG. 9 is a section view of the support arm structure of the luminaire assembly of FIGS. 8a and 8b.

### DETAILED DESCRIPTION OF THE INVENTION

The non-restrictive preferred embodiment now described will focus on within-plenum recessed luminaires for the purposes of illustrating the inventive means of a preferred embodiment, but is not limited to same and may be applied to a wide variety of luminaires such as suspended luminaires, luminaires affixed to walls, independent luminaires generally located in the proximity of a substrate which can be used as a soundboard, as well as all types of luminaire styles and configurations with varied light emitting elements. The inventive means described herein applies to all luminaires, regardless of the environment to which they are installed, or placed.

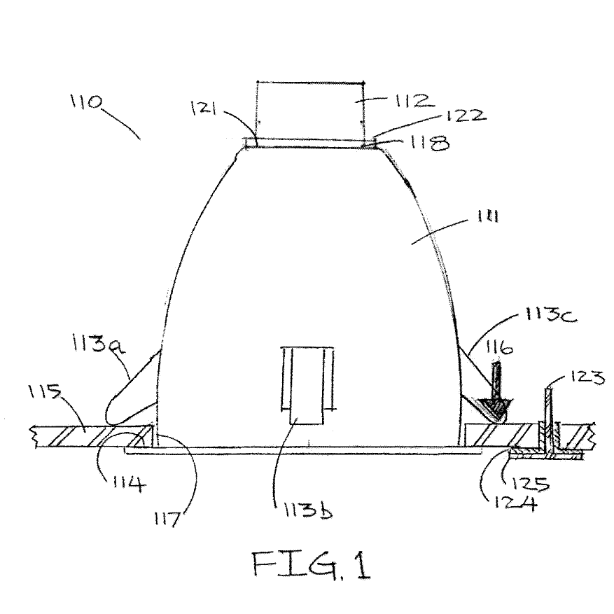

Generally, and referring now to FIG. 1, a recessed luminaire 110 comprises an outer housing or reflector 11, which reflector or housing typically has its lower flange 114 caused to be in contact with the substrate 115 by way of a means for mechanically associating 113 said flange 114 and said substrate 115 such as a clamping means affixing the luminaire 110 to the substrate 115. It should be noted that mechanical association can be replaced by any other means such as but not limited to adhesives or other mechanical type means. As the outer luminaire housing 111 is relatively rigid by way of its geometry or can be made rigid by adding structure to its geometry, an inertial type acoustic actuator 112 may be affixed to the outer housing 111 by a transmission means 118 in various ways whereby its mechanical acoustic energy would be induced into the luminaire 110 and would then be transmitted by way of means to mechanically associate 113 the flange 114 and the substrate 115. Acoustic vibration energy mechanically transferred to the substrate 115 causes a substrate to function as a distributed mode loudspeaker and produce desired audio content. Where the term “inertial type acoustic actuator 112” is used herein, other commonly known sound producers such as an audio exciter, distributed mode loudspeaker, or vibrational speaker may be substituted. The terms inertial type acoustic actuator is interchangeable with audio transducer and both terms should be read to encompass the aforementioned sound producers.

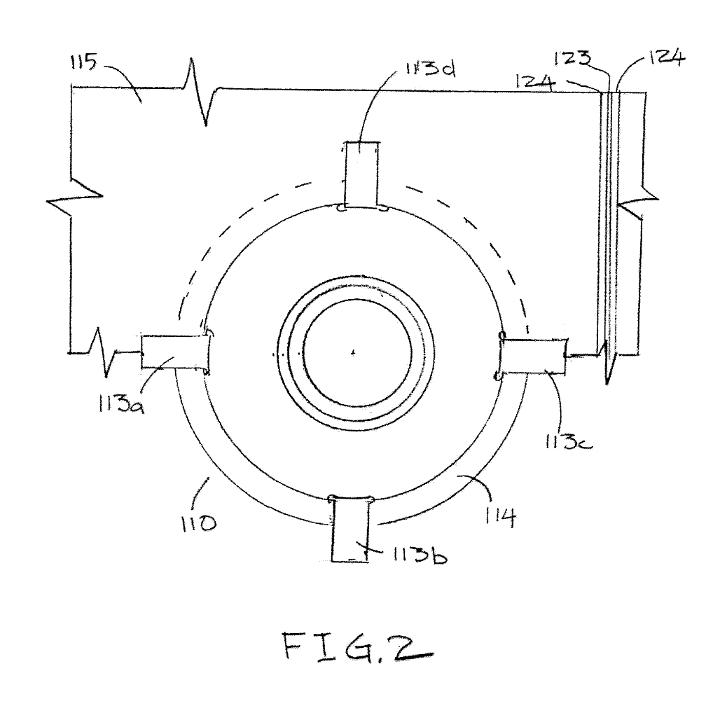

Now referring more specifically to FIGS. 1 and 2, one embodiment of the present invention comprises the recessed luminaire assembly 110 installed to the substrate 115 which is a ceiling. The luminaire 110 is characterized by its outer housing structure 111. This luminaire housing 111 of this embodiment is co-axially located over a hole or opening 117 in said ceiling 115 into which the luminaire 110 is installed. The housing 111 may also act as an optical reflector to control the light dispersion of the light source found within. The light source may be one of many light emitting sources including but not limited to fluorescent lamps, light emitting diodes, or any other light emitting source. The housing 111 is also characterized by the lower flange 114, which flange assists with the installation process and is used with means for mechanically associating which, in this embodiment, is a mechanical clamping means 113. As shown in FIGS. 1 and FIG. 2, the mechanical clamping means 113 is characterized by at least one but preferably several equally spaced clamping elements as shown by 113a, 113b, 113c, 113d maximizing the contact surface area between the clamping means 113 and the substrate will improve the audio contact with the substrate 115 when installed into opening 117. There are many variations of these clamping or mechanically affixing means found in the marketplace. Other clamping means may vary to some degree from the means illustrated. Someone skilled in the art may conceive of other means to mechanically associate 113 which optimizes the transfer of acoustic energy from the luminaire 110 to the substrate 115. The principals of the clamping means shown shall not be limited to same and are shown to illustrate the principals of this inventive system.

Preferably the clamping means 113 is height adjustable. The height adjustment may be achieved by employing any of a number of means known to one of ordinary skill in the art such as an adjustment screw found within the housing. As the screw is turned, the upper portion of the clamping means 113 is pulled downwards creating a downward and generally vertically oriented force as shown by arrows 116.

By way of example in the preferred illustrative embodiment, the inertial type audio actuator 112 may be mounted on a top portion 121 of the luminaire 110. Said transmission means 118 may comprise an intermediary mounting disc 122 which also acts as an intermediary connecting means whereby the disc 122 may be mechanically or adhesively affixed to the top portion 121 of the luminaire housing 111, and the audio transducer 112 may be affixed to the mounting disc 122 mechanically or adhesively by way of a variety of means including but not limited to a screw type means.

When the audio transducer 112 is excited by an audio signal, it vibrates and transmits this energy through the somewhat rigid luminaire housing 111 to the flange 114 and by way of the clamping means 113 tightly securing the luminaire assembly 110 to the substrate 115, the mechanical energy is transferred to the substrate 115 which will act as a soundboard to emit desired audio content. The substrate 115 then acts as a distributed mode loudspeaker. For the purpose of all illustrative figures, the figures will show a cross sectional view of the substrate 115 taken on or about the transverse centerline of the luminaire 110.

Alternatively, the inertial type audio actuator 112 may be affixed directly or indirectly to any part of the luminaire 110. The actual luminaire may then be energized acoustically by the inertial type audio actuator 112 whereby the actual luminaire or any one or more parts thereof acts as a sound emitting soundboard resulting from the vibrational energy induced therein by the inertial type audio actuator 112. Parts of the luminaire can be chosen which are compliant enough to vibrate in the appropriate manner.

Once energy from the audio transducer 112 is induced into or transferred to the substrate 115, it is desirable to isolate the substrate 115 from other elements in the ceiling plenum which may include a T-bar suspension system 123 or other ceiling tiles 124. Such isolation will improve the sound transmission and can be accomplished by using various means. One example is to employ an elastomeric material 125 which is desirable. The elastomeric material controls the acoustic output of the substrate 115, without transferring acoustically dissonant vibration to surrounding elements.

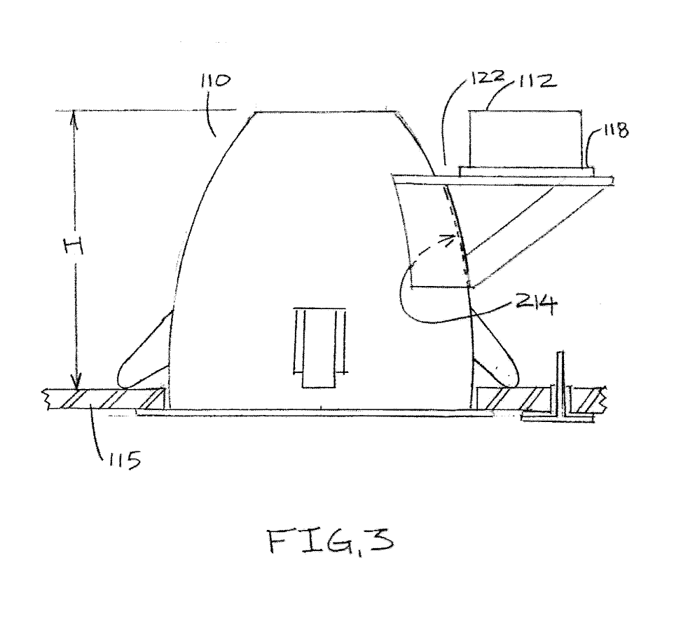

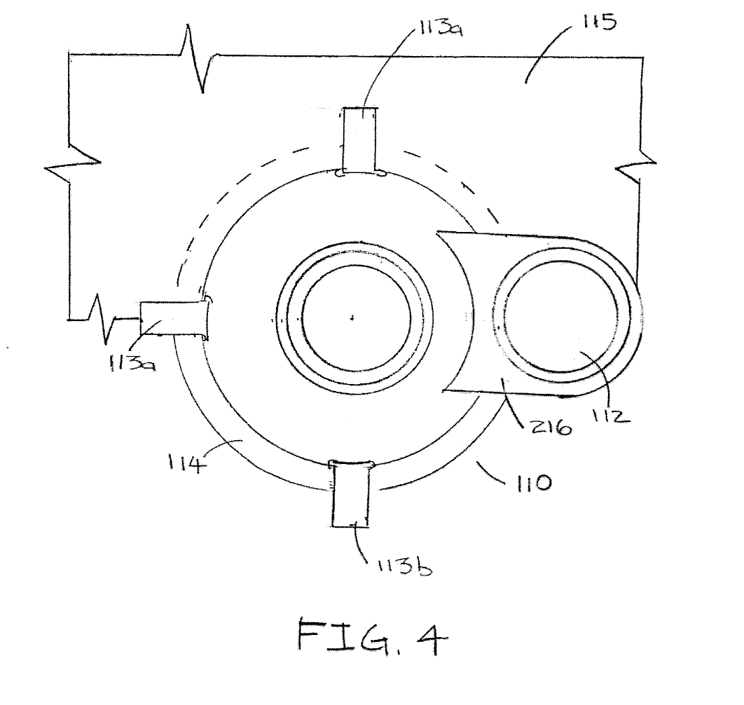

Now referring to figure to FIGS. 3 and 4, the luminaire 110 depicts an alternative means for transmission 122 to transmit the audio energy produced by the audio transducer 112. If the space into which the entire assembly is installed is height restricted (for example as shown by “H” in FIG. 3), or if there are devices or equipment already mounted on top of the luminaire, the transmission means 118, 122 may be made of light yet rigid material such as die cast aluminum and the inertial type audio transducer 112 may be mounted onto the transmission means 118, 122 such that the mechanical audio vibration energy can travel through the transmission means 118, 122 and be transferred to the rigid luminaire housing 111 or other elements of the luminaire 110. The path of the audio energy would continue as previously described to the substrate 115 where the substrate would function as an audio source or alternatively another portion of the luminaire would be excited acoustically by the energy output by the inertial acoustic actuator 112. The transmission means 122 may be mechanically, adhesively, welded or otherwise affixed to the luminaire housing 111 or any other appropriate part of the luminaire 110.

In an additional preferred embodiment, shown in FIG. 3 and FIG. 4 an audio transmission means 210 may be formed of rigid thin wall material having at least one longitudinal reinforcing rib 212 and to provide a platform structure 216 which can receive and support an inertial type acoustic actuator 112. A contact surface 214 of transduction means 210 interfaces with the housing of the luminaire 111 and acts as the energy transmission surface. Additionally, a retention band 215 can further increase the surface area between the transmission means 210 and the luminaire housing 111 to more effectively transmit the acoustic energy produced by the acoustic transducer 112.

There are many other variations for the transmission of audio energy that would function well for the purposes intended and would be obvious to someone skilled in the art. Essentially the means for mechanically associating 113 must comprise features and materials well suited to transmit the audio energy into the substrate 115 and may include increasing the surface contact between means for mechanically associating 113 to the transducer 112 to more fully or equally distribute the compression load into the substrate 115. It should also be noted that for transmission efficiency, means for mechanically associating 113 may be used mechanically or adhesively, or combinations of other means to affix the luminaire 110 to the substrate 115.

It should be stated that in all instances where any luminaire such as but not limited to luminaire 110 is used as an audio transmission means, all parts forming the luminaire assembly 110 are preferably firmly affixed one to the other. If any parts are not either mechanically, adhesively affixed, welded or otherwise rendered unable to vibrate between each other, then a vibration dampening material such as but not limited to an elastomeric foam should be placed between the vibrating parts mating surfaces to attenuate any unwanted vibration, thereby preserving and propagating more true representation of the audio energy.

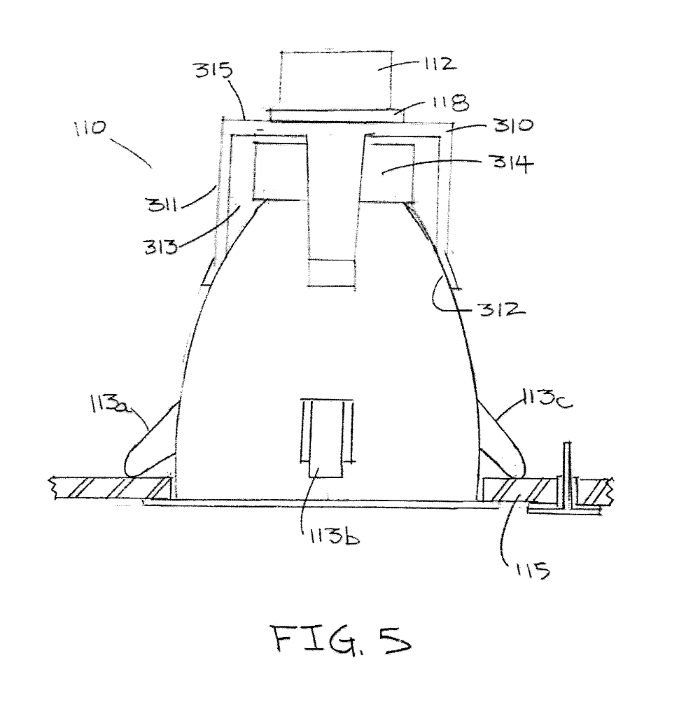

Referring now to FIG. 5, yet another representation of a non-restrictive preferred embodiment of the present invention is represented. Transmission device 310 supports an audio transducer 112 mounted either directly to the transmission device using at least one screw, adhesives or other like manners, or indirectly by an intermediary mounting disc 118 and which is made to contact the housing of luminaire 111 or another appropriate part or parts of the luminaire. The transmission device 310 is characterized by at least one support legs 311, which if more than one is used or the single leg is perforated, would leave openings 313 which can assist with convective heat dissipation of the luminaire 111. It should be noted that the only contact surfaces of the transmission structure 310 are surfaces 312 of transmission structure 310 making contact with the luminaire 110. The luminaire 110 may comprise additional elements 314 including but not limited to electronics, heat sinks or other devices. The transmission structure 310 comprises a receiving surface 315 which can be made to stand above these elements 314 without making any contact as contact would induce unwanted vibration to the elements 314. The legs 311 terminating with contacting surfaces 312 may be affixed to the luminaire 110 as are all transmission devices described herein mechanically, adhesively or otherwise. Mechanical means may include but are not limited to screws, welding, sprung retention means and clips.

The non-restrictive preferred embodiment described herein often include associated electronics such as but not limited to, ballasts, transformers, power supplies, controllers, and other electronic means to assist with the functioning of the light output means or audio control and generation.

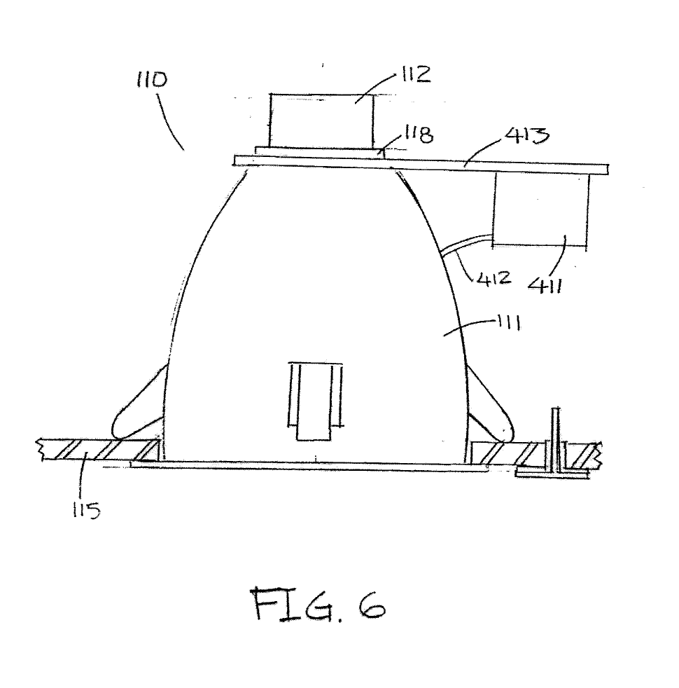

Now referring to FIG. 6, the luminaire 110 includes electronic housing 411, which may house any combination of the above mentioned electronics. Housing 411 may be secured to the luminaire housing 111 by way many means one of which may include a support plate 413, which plate is in turn secured to the luminaire housing 111. A cable 412 may feed power, Ethernet audio content or other luminaire or audio control means to the luminaire 110. This would apply to all embodiments shown herein. This electronic housing 410 may take on a number of different forms relative to the luminaire design, and is described herein to exemplify only one preferred embodiments. This same housing 410, may then house electronics such as but not limited to those electronics hereinabove stated. Cables 419 and 420 may feed lighting control and audio control and content to the luminaire 110 and inertial type acoustics . actuator.

Referring to FIG. 5, if the audio electronics are to be segregated from the luminaire electronics, then a separate housing 414 may be affixed to plate 413 which would be extended for this purpose. Separating the audio electronics would at times help isolate audio electronics from luminaire electronics to prevent interference of the audio signal by such luminaire electronics. Audio signal and power may again be supplied to the audio transducer 112 by one or more cables 420. Either or both electronic component housings 411 and 414, or alternatively their housed components may be housed within the luminaire housing 111 as would be known to someone skilled in the art. Alternatively, either or both audio electronics and luminaire electronics may be located in either or both housings 411 and 414, which housings would be at considerable distance from the luminaire 110. Supply of audio content and control and lighting control would use one or more cables 412 affixed to inertial type audio actuator 112 and, or luminaire 110. The cable 412 may be an Ethernet cable.

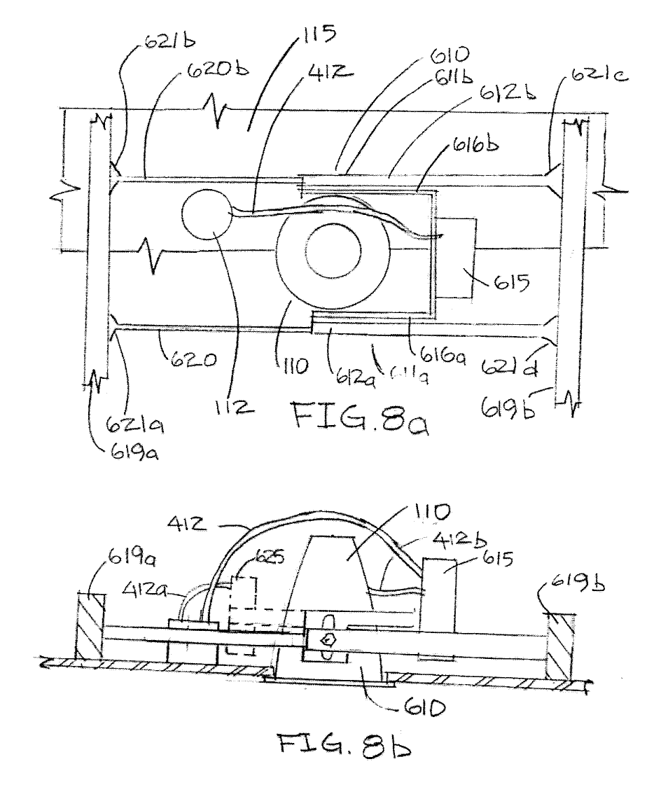

Referring to FIG. 8A and FIG. 8B, recessed luminaires or luminaires installed into a ceiling plenum may not be affixed to and supported by the substrate in the hereinabove described manner, but may commonly be installed using a variable length support structure attached to other structures found in the ceiling plenum. This is representative of another non-restrictive preferred embodiment whereby the luminaire 610 is used as a housing means for audio equipment such as but not limited to an audio amplifier and whereby the luminaire 610 supports the use of an inertial type audio transducer 112.

This support structure 610 typically comprises at least one and preferably two slidably assembled tracks 611a and 611b offset a distance “Y” typically by the luminaire housing 111 itself. The support structure 610 may be able to telescope in order to be able to be affixed at its extremities 621a, 621b, 622a and 622b to commonly found ceiling structures such as beams 619a and 619b which may also represent the frame of a ceiling grid structure or other in plenum structures. This housing module 615 can house luminaire electronics, acoustic electronics, or both. Another housing 625 can be seen in FIG. 8b in dashed lines and is held in place by extensions of arms 616a and 616b. Audio electronics may be better served housed in this second housing 625 for the same reasons as described for housing 414. Alternatively all luminaire electronics may be shielded electromagnetically and otherwise to reduce audio interference.

The support structure 610 positions the luminaire housing 111 relative to the substrate 115 and hole 117 horizontally, the position adjusting means 613a, and 613b may serve to position the luminaire 110 in a vertical axis relative to substrate 115 as more fully represented in FIG. 6b.

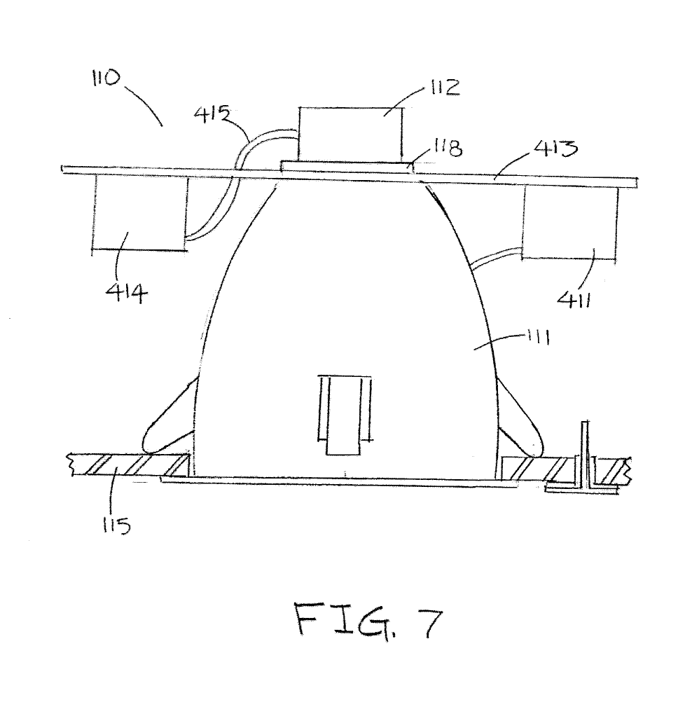

This provides a variation of the inventive means described herein. Utilizing the inventive integration of luminaire technology integrated with audio technology, the luminaire may carry the audio equipment, including but not limited to content delivery means, audio amplifier, and audio control means in housing module 615 or 625. It should be noted that the housing modules 615 or 625 may form part of or be integrated into the luminaire 110 in a variety of ways which would be known to someone skilled in the art. From either housing module 615 or 625 a speaker output wire 420 can be linked to the inertial type acoustic actuator 112 and power, audio control, audio content, and luminaire control can be supplied by cable 412a and 412b. Housings 615 and 625 as well as cables 412a, 412b, 419 and 420 would function at least in the same way housings 411 and 414 and said cables 412, 419 and 420 of FIG. 6 and FIG. 7. The inertial type acoustic actuator may then be affixed adhesively or mechanically or by other means to the substrate 115 to which the luminaire 110 transpierces. The inertial type audio transducer 112 once mounted to the substrate 115 and powered by the acoustic electronics found in housing 615 or 625 may then cause the substrate 115 to act as a soundboard and emit audio signal. Alternatively the audio transducer 112 may be affixed to an alternate substrate found generally in the local area and which substrate can act as a soundboard. As shown, the audio signal is generally generated in the vicinity of the inertial type acoustic actuator. If radio frequency transmission is used, then a radio frequency emitter which may be collocated with the luminaire, can send out a signal to the inertial type acoustic actuator which may not be in the general vicinity of the luminaire 110.

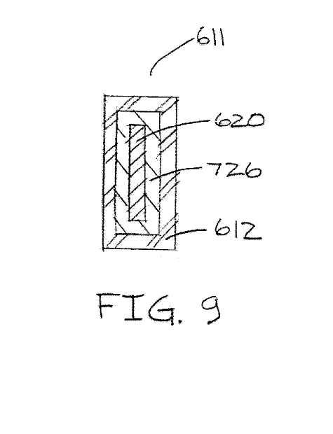

Attenuating vibration in all elements in general vicinity of the substrate 115 and the luminaire structure 610 is advisable. All mating surfaced between the varied parts forming the system should be either firmly fastened so as not to vibrate between one and other, and which may use materials and hardware commonly used for this purpose. Referring to FIG. 9, sliding structure rails 611 comprising of structural elements 612 and 620 would preferably benefit by this with the addition of vibration attenuating sleeve 726 which can be made of a soft vibration absorbing lubricious polymer such as but not limited to low density polyethylene.

The present invention has been described in an illustrative manner. It is to be understood that the terminology which has been used is intended to be in the nature of words of description rather than of limitation. Many modifications and variations of the present invention are possible in light of the above teachings. Therefore, the present invention may be practiced otherwise than as specifically described.

1. A luminaire assembly comprising a plurality of elements including an audio transducer, an outer housing, and a light source, said transducer acoustically associated with one of said plurality of elements causing that element to emit sound.

2. A recessed luminaire assembly comprising a substrate, an audio transducer, an outer housing, and means for mechanically associating said outer housing and said substrate for accurately transforming acoustic energy from said inertial type acoustic actuator to said substrate causing said substrate to function as a sound board.

3. The assembly of claim 2 wherein said outer housing comprises a flange and said means for mechanically associating comprises mechanical clamping means and said substrate comprises a ceiling having an opening into which said assembly is installed.

4. The assembly of claim 2 wherein said luminaire assembly further comprises a top portion, and a transmission means.

5. The assembly of claim 4 wherein said transmission means comprises an intermediary disc associated with said top portion of the luminaire and the audio transducer and said intermediary disc and said top portion are associated.

6. The assembly of claim 3 wherein said mechanical clamping means comprises at least one clamping element comprising adjustable means to create a downward force from said mechanical clamping means to said substrate.

7. A luminaire assembly comprising a substrate, transmission means, an audio transducer, and an outer housing, wherein said transmission means transfers acoustic energy from the transducer to said housing causing said housing to function as a soundboard.

8. The assembly of claim 4 or 7 wherein said substrate is substantially isolated from other elements to which some of the acoustic energy would otherwise be transferred.

9. The assembly of claim 4 or 7 further comprising a plurality of structural elements and an elastomeric material positioned to substantially isolate said substrate from at least one of said plurality of structural elements.

10. The assembly of claim 2 wherein said transmission means transfers acoustic energy from said audio transducer to said outer housing.

11. The assembly of claim 4 wherein said transmission means comprises a platform cantilevered from said outer housing, said audio transducer acoustically associated with said platform for transmitting acoustic energy from said audio transducer to said outer housing.

12. The assembly of claim 11 wherein said transmission means further comprises a contact surface associated with said outer housing thereby increasing surface area contact between said transmission means and said outer housing.

13. The assembly of claim 11 or 6 further comprising vibration dampening material between at least some of the components of the assembly to control unwanted propogation of the acoustic energy.

14. The assembly of claim 4 wherein said assembly further comprises a top portion and said transmission means comprises a platform, at least two support legs between which is at least one opening, said legs associated with said outerhousing of said luminaire, and a space between said top portion of said luminaire and said transmission means.

15. The assembly of claim 14 wherein said transmission means contacts said outerhousing only via said at least two support legs.

16. The assembly of claim 14 wherein at least one of said support legs comprises openings for encouraging convective flow of heat away from the luminaire assembly.

17. The assembly of claims 2, 4 or 7 further comprising an electronic housing means.

18. The assembly of claim 2, 4 or 7 further comprising an electronic housing means for segregating electronic means to assist with functioning of light and audio control and generation from said outer housing.

19. The assembly of claim 18 further comprising a support plate associated with said electronic housing means for cantilevering said electronic housing means from said outer housing.

20. The assembly of claim 17 further comprising a second electronic housing means wherein said second electronic housing means houses only electronic means to assist with audio control.

21. The assembly of claim 17 further comprising a cable to supply power.

22. The assembly of claim 17 further comprising a cable to supply power and a cable to provide audio control means.

23. The assembly of claim 2, 4 or 7 further comprising a variable length support structure for positioning said assembly relative to said substrate.

24. The assembly claimed in claim 23 wherein the variable length support structure is secured to at least one substantially immovable structural element.

25. The assembly claimed in claim 24 wherein said variable length support structure comprises at least one slidably assembled track.

26. The assembly claimed in claim 25 wherein said support structure includes a first end and a second end, said first end and said second end slidably related to adjust the length of the support structure, at least one of said first end and said second end affixed to said substantially immovable structural element.

27. The assembly of claim 17 further comprising one or more cables for conveying power, audio source, audio control signals, and lighting control signals.
